(19) United States
(12) Patent Application Publication
(10) Pub. No.: US 2015/0230510 A1
(43) Pub. Date: Aug. 20, 2015

(54) INGESTIBLE NUTRITIONAL DOSE FORMS FOR INDUCING SATIETY

(71) Applicant: McNeil Nutritionals, LLC, Fort Washington, PA (US)

(72) Inventors: Juan Navia, Doylestown, PA (US); Leo B. Kriksunov, Ithaca, NY (US)

(21) Appl. No.: 14/624,636

(22) Filed: Feb. 18, 2015

Related U.S. Application Data
(60) Provisional application No. 61/941,669, filed on Feb. 19, 2014.

(51) Int. Cl. A23L 1/308

(52) U.S. Cl. CPC A23L 1/3082; A23L 1/308

(57) ABSTRACT

Ingestible nutritional dose forms are disclosed. The ingestible nutritional dose forms curb appetite, reduce food intake and/or reduce satiety. Methods for making and methods for using the ingestible nutritional dose forms are also disclosed.

### CROSS REFERENCE TO RELATED APPLICATIONS

This application claims priority from U.S. Provisional Application Ser. No. 61/941,669, filed Feb. 19, 2014, the contents of which are hereby incorporated by reference in their entirety.

### FIELD OF THE INVENTION

The present invention relates to ingestible nutritional dose forms. The present invention also relates to methods of making and methods of using the ingestible nutritional dose forms to curb appetite, reduce food intake, and induce satiety, particularly in persons who are overweight or obese.

### BACKGROUND OF THE INVENTION

Excessive weight and obesity are major health concerns worldwide. Associated complications may include hypertension, diabetes, coronary artery disease, stroke, congestive heart failure, venous disease, multiple orthopedic problems and pulmonary insufficiency with markedly decreased life expectancy. Intentional weight loss, however, can improve many of these medical complications. Medical management including diet, psychotherapy, medication and behavioral modification techniques are not able to provide adequate management of this problem for all patients.

Non-surgical approaches for the treatment of excessive weight and obesity include voluntary dieting which is often unsuccessful since many persons do not possess sufficient willpower to limit the intake of food. Certain dietary and nutritional supplements are moderately successful in inducing satiety, but are not capable of completely resolving the problem.

In addition to behavioral and dietary modification, several surgical techniques have been tried which induce malabsorption by reducing the absorptive surface of the small intestine or modifying the stomach to reduce a patients' desire to eat. Although gastric reduction surgery in which the stomach's volume is reduced sometimes shows early success, many patients do not exhibit prolonged weight loss due to the stomach's size stretching over time. Other surgical approaches combine gastric volume reduction by either partition or bypass with a reduction in the absorptive surface of the small intestine. These procedures may be hazardous and may create postoperative complications. Such procedures typically are invasive, require a long recuperation time and subject the patient to pain and discomfort. These procedures can be expensive and can therefore place a burden on the health care system.

Other endoscopic approaches include implantation of gastric balloons that prevent overeating by occupying volume within the stomach. This fills a portion of the stomach and provides the patient with a feeling of fullness, thereby reducing food intake. Many problems are associated with the use of gastric balloon devices, including poor patient tolerance and complications due to rupture, migration, and pressure trauma to the gastrointestinal (GI) tract. Other devices have been designed to attempt to limit the absorption of nutrients in the duodenum by funneling the food through a tube so that the digestive process bypasses portions of the small intestine entirely. By interrupting the intermixing of the digestive fluids and/or limiting the residence period within the stomach, it is believed that the food materials will not fully digest into particles small enough to be absorbed by the body.

U.S. Pat. No. 8,147,561, “Methods and devices to curb appetite and/or reduce food intake” and U.S. Pat. No. 7,931,693, “Method and apparatus for reducing obesity”; as well as U.S. Patent Publications Nos. 20070293885; 20090187206; 20110190684; 20120172999; all by Binmoeller, Endosphere, Inc., disclose a duodenal/small intestine insert that helps curb appetite and/or reduce food intake.

U.S. Patent Publication No. 20110137227 to McKinley et al. discloses devices that are adapted to and configured for use within the duodenum of a mammal. The reference discloses that the device contains a spine having a proximal end and a distal end; an atraumatic feature positioned on at least one of the proximal end and the distal end of the spine; and a flow reduction element positioned along the spine and having a variable porosity along its length.

The devices and methods described above require installation into and potentially removal from the small intestine and thus require a complex and invasive operation to be performed on a patient by a medical professional. Another disadvantage of these devices is that the signaling and effects of the device are not chronologically limited to certain periods of time such as during meals and after meals. The devices may thus result in the nervous system adapting and eventually ignoring the device signaling and effects.

While the above methods and devices may be somewhat effective at limiting the absorption of consumed food and/or inducing satiety sensations resulting in decreased food intake, the devices require complicated installation and removal and may need to be adjusted/refitted for individual users.

U.S. Pat. No. 8,295,932 to Bitton et al, Metacure Limited, discloses an ingestible capsule that contains an electrode device and one or more flexible support elements that expand in the stomach of a subject.

U.S. Pat. No. 8,530,514 to Sein et al., DSM IP Assets B.V., discloses a method for inducing satiety comprising administering a lipid of which at least a part is in a crystal form in the small intestine. The patent discloses that the lipid can be provided enterically or orally.

U.S. Pat. No. 8,541,392 to Wolf et al., Abbott Laboratories, discloses an induced viscosity fiber system and its use to induce a feeling of fullness and satiety. The patent discloses that the system, which contains a neutral soluble fiber and a more soluble component, can be incorporated into food products and consumed during a meal or snack. The examples disclose the incorporation of the system in a liquid nutritional composition.

There remains a need for an improved in non-surgical devices designed to induce weight loss and/or a reduction in food intake and/or curb appetite.

### SUMMARY OF THE INVENTION

According to the present invention, if the passage of partially digested food is partially blocked and the flow rate through the small intestine is reduced, then the emptying of the stomach and the duodenum will occur slower. This in turn will create a feeling of satiety and will decrease the consumption of food by an overweight or obese patient.

Additionally, because a large amount of the nutritional absorption occurs in the small intestine, if the amount of absorptive surface area of the walls of the small intestine is restricted or partially blocked, thus interrupting or reducing the intermixing of the digestive fluids, the partially digested food materials are not readily absorbed by the small intestine or other absorptive organs of the body. The partially digested food materials are then passed to the large intestine for elimination from the body with limited caloric absorption by the body.

Furthermore, the reduction of flow rate and/or of food breakdown products through the small intestine may result in distension of the small intestine, or increase the contact time between the small intestine and the partially digested food. This distention or increased contact time may activate osmoreceptors that may release hormones and neurotransmitters such as cholecystokinins (CCK) and neural signals that may induce satiety.

The amount of food that individuals consume is largely dependent on biological signals between the gut and the brain. Specifically, hormonal signals from the gut to the brain are correlated with both the onset and cessation of food intake. While increased levels of hormones such as ghrelin, motilin and agouti-related peptide are involved in the promotion of appetite and the onset of food intake, increased levels of a number of other hormones are involved in the cessation of food intake.

Various biologic events contribute to the physiologic cessation of food intake. Generally, as a meal is consumed, the ingested food and by-products of digestion interact with an array of receptors along the GI tract to create satiety signals. Satiety signals communicate to the brain that an adequate amount of food has been consumed and that an organism should stop eating. Specifically, GI tract chemoreceptors respond to, without limitation, products of digestion (such as sugars, fatty acids, amino acids and peptides) while stretch and mechanoreceptors in the stomach and proximal small intestine respond to, without limitation, the physical presence of consumed foods. Chemoreceptors respond to the products of digestion by, without limitation, causing the release of hormones or other molecular signals. These released hormones and/or other molecular signals can stimulate nerve fibers to send satiety signals to the brain. The arrival of these signals in the brain can trigger a variety of neural pathways that can reduce food intake. The released hormones and/or other molecular signals can also travel to the brain themselves to help create signals of satiety. Stretch and mechanoreceptors generally send satiety signals to the brain through, without limitation, stimulation of nerve fibers in the periphery that signal the brain. The present invention provides methods and ingestible and digestible dose forms and supplements that help to reduce food intake by providing non-surgical means that trigger the aforementioned biological events that contribute to the creation of satiety signals.

In one embodiment, the triggering of the initial physiological effect is caused by the slowing of the passage of consumed food through the GI tract of the organism. In one embodiment, an elongated ingestible member or string is deployed in the small intestine and has a diameter sized to restrict but not occlude the movement of consumed foods through the small intestine.

In another embodiment, the triggering of the initial physiological effect that contributes to the creation of one or more biological satiety signals is caused by contract and/or pressure exerted on the wall of the small intestine by the elongated ingestible member or string, particularly during segmentation and peristalsis.

In another embodiment, the triggering of biological satiety signals occurs through activation of at least one chemoreceptor. In another embodiment, the triggering occurs through the activation of at least one stretch receptor. In another embodiment, the triggering occurs through the activation of at least one mechanoreceptor.

In another embodiment, one or more biological signals of satiety are transmitted at least in part through stimulation of afferent nerve fibers. In another embodiment, the afferent nerve fibers are vagal afferent nerve fibers.

In another embodiment, the one or more biological signals of satiety is transmitted at least in part by molecules released as a result of stimulation of the chemoreceptor. In another embodiment, the molecules are hormones. In another embodiment, the molecules are selected from one or more of the group consisting of cholecystokinin, peptide YY.sub.3-36, glucagon-like peptide 1, gastric-inhibitory peptide, neurotensin, amylin, leptin, bombesin, calcitonin, calcitonin gene-related peptide, somatostatin, neuromedin U and glucagon.

In one embodiment, the method includes orally administering through swallowing a tightly packed elongated ingestible and at least partially digestible member or string, which is then deployed as an elongated string in the small intestine of an organism wherein the elongated ingestible member or string has a diameter that is less than the internal or passage diameter of the small intestine of the organism and wherein the string is capable of remaining in the small intestine for a period of time. In one embodiment of this method, the string triggers a physiological effect that contributes to the creation of one or more biological signals of satiety. In another embodiment of this method, the elongated ingestible member responds differently to segmentation and peristalsis when compared to chyme and sends different signals to the sensing systems in the small intestine.

In another embodiment, the diameter of the elongated ingestible member is sized to restrict but not occlude the movement of digested food through the small intestine. In another embodiment, the triggering of the physiological effect is caused by the slowing of the passage of consumed food through the small intestine of the organism.

In some embodiments, the physical dimension of the elongated ingestible member is such that it distends a portion of the small intestine, and the distension is sufficient to cause stretch receptors or other neurons of the small intestine to generate a satiety signal in response thereto. The physical dimensions or features of the elongated ingestible member that cause distension include any of length, width, volume, density, weight, porosity, or surface properties.

The present invention provides methods and nutritional dose forms to reduce food intake by one or more of:
a) slowing the passage of food so that food remains in the GI tract for a longer period of time and thereby triggers satiety signals for a longer period of time;
b) stimulating stretch and mechanoreceptors within the GI tract to send satiety signals to the brain to decrease the likelihood or amount of food intake; and/or
c) stimulating chemoreceptors within the GI tract to send satiety signals to the brain to decrease the likelihood or amount of food intake.

### BRIEF DESCRIPTION OF THE DRAWINGS

FIGS. 1A-1G are views of the ingestible nutritional dose forms of the invention, wherein the ingestible nutritional dose forms are made of an elongated ingestible and at least partially digestible string;

FIGS. 2A-2B are views of the ingestible nutritional dose forms of the invention, wherein the ingestible nutritional dose forms are made from two elongated elements having two different coefficients of contraction or drying;

FIGS. 3A-3B are views of the ingestible nutritional dose forms of the invention, wherein the ingestible nutritional dose forms are made from a bi-layer sheet;

FIGS. 4A-4D are views of the ingestible nutritional dose forms of the invention, wherein the ingestible nutritional dose forms are made from multilayer sheets;

FIGS. 5A-5B are views of the ingestible nutritional dose forms of the invention, wherein the ingestible nutritional dose forms contain anchoring material;

FIGS. 6A-6C are views of the ingestible nutritional dose forms of the invention, wherein the ingestible nutritional dose forms contain a nutritional or bioactive component; and

FIGS. 7A-7D are views of the ingestible nutritional dose forms of the invention, wherein the ingestible nutritional dose forms contain slow digestible or non-digestible segments.

### DETAILED DESCRIPTION OF THE INVENTION

### Dose Forms

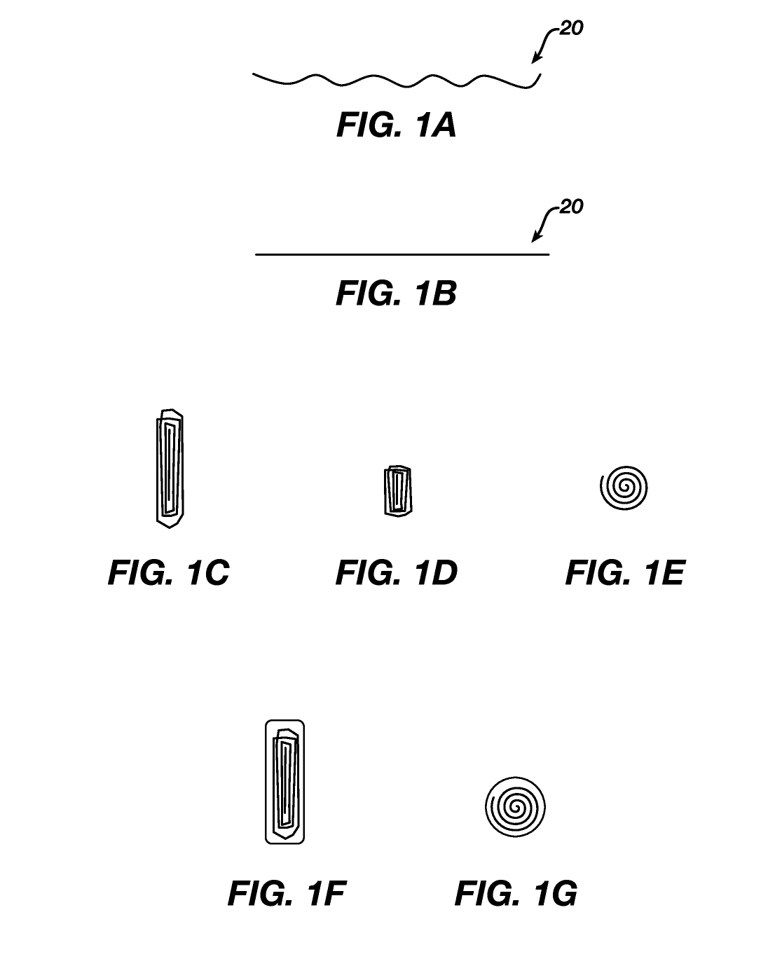

Referring now to FIG. 1, an ingestible nutritional dose form or swallowable dose form 10, made of an elongated ingestible and at least partially digestible member or string 20, is shown. String 20 is an elongated member and can be straight or wavy as shown in FIGS. 1A and 1B. String 20 can have approximately round cross-section, oval cross-section, or rectangular cross-section. In case of flattened cross-section such as oval or rectangle, string 20 is forming a ribbon. One or more strings 20 are wound into a compact swallowable form 10 which can be shaped as an elongate capsule (FIG. 1C); shortened elongate capsule (FIG. 1D); round capsule or tablet (FIG. 1E). One or more strings 20 are further encapsulated into a soluble or digestible shell 30 forming compact swallowable form 10a which can be shaped as an elongate capsule (FIG. 1F) or round capsule or tablet (FIG. 1G); or similar swallowable and optionally encapsulated dose forms.

According to an embodiment, swallowable form 10 upon ingestion deploys and unfurls string 20 in the small intestine, whereby the elongated, string member 20 triggers a physiological effect that contributes to the creation of one or more biological signals of satiety.

String 20 preferably unfurls in the small intestine. It can also at least partially unfurl in the stomach. String 20 in dry form, prior to swelling in the GI tract, is preferably from about 0.1 mm to about 3 mm in diameter and from about 1 cm to about 50 cm long, more preferably from about 0.2 mm to about 2 mm diameter and about 2 cm to about 5-10 cm long. Upon swelling in the GI tract, string 20 is preferably from about 0.3 mm to about 10 mm in diameter and from about 1 cm to about 50 cm long. In some embodiments, string 20 is about 1 mm to about 5 mm in diameter and about 2 cm to about 20 cm long once unfurled and swelled in the small intestine. In some embodiments elongated ingestible member or string 20 has the ratio of length to diameter, or aspect ratio, prior to swallowing of about 5 to about 1000, more preferably about 10 to about 300; and after swelling in the GI tract, aspect ratio of about 3 to about 250, more preferably about 3 to about 100.

Swallowable dose form 10 has dimensions which make it easy for swallowing, i.e., similar to oral drug and supplements/vitamins dose forms sizes and shapes. In some embodiments, swallowable dose form 10 is in a form of a capsule having length of about 15 mm to about 25 mm and diameter of about 5 mm to about 12 mm.

### Forming Dose Form

Ingestible string 20 is initially packaged into a swallowable form 10 by the following exemplary methods:
a) Folding string 20 multiple times or rolling up into a compact roll to form swallowable dose form 10. Dose form 10 can be optionally coated with a coating configured to keep the package together and optionally to prevent untanglement in the stomach.
b) Folding string 20 multiple times or rolling up into a compact roll and inserting into a soluble shell 30 configured to keep the package together and optionally to prevent untanglement in the stomach.
c) Self-folding.
d) Folding multilayer sheets into cylindrical or elliptical cross-section pre-forms and then cutting.

Several folded or wound strings 20 can form swallowable dose form 10, by pressing or entangling them together, and/or by encapsulating several strings 20 into a soluble or digestible shell 30.

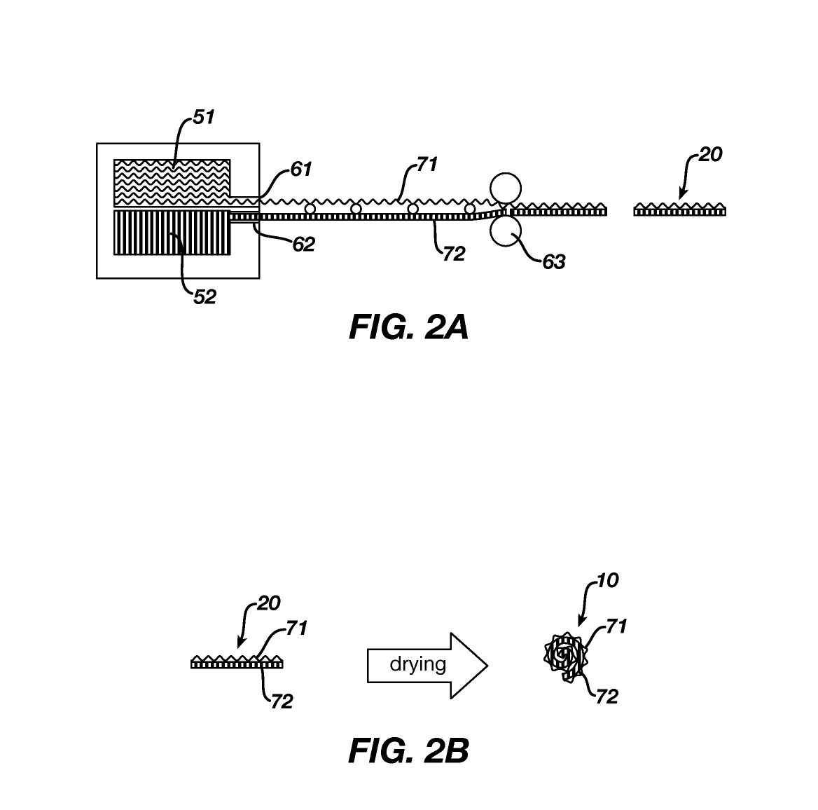

Referring now to FIG. 2, string 20 can be rendered self-folding by forming string 20 of two elongated elements 71 and 72 having different coefficients of contraction or shrinkage on drying. In one embodiment, a dual extrusion process is utilized to co-extrude first material 51 and second material 52 through die apertures 61 and 62 as shown in FIG. 2A. Elongated elements 71 and 72 are joined together upon extrusion, either immediately upon exiting die apertures 61 and 62 (not shown) or using rollers 63 to press elongated elements 71 and 72 together, after which the joined elongated elements 71 and 72 are cut to specific length, forming string 20. String 20 is then allowed to dry. As shown in FIG. 2B, due to different coefficients of contraction or shrinkage on drying of materials 51 and 52, string 20 self-folds or self-wraps into dose form 10. Upon hydrating in the GI tract, string 20 will unfold into an elongated form. In the schematic shown in FIG. 2, material 52 forming elongated element 72 has higher contraction on drying vs. material 51 forming elongated element 71. In other embodiments (not shown), string 20 can be formed not in dual but in triple extrusion process, with three elongated elements forming string 20.

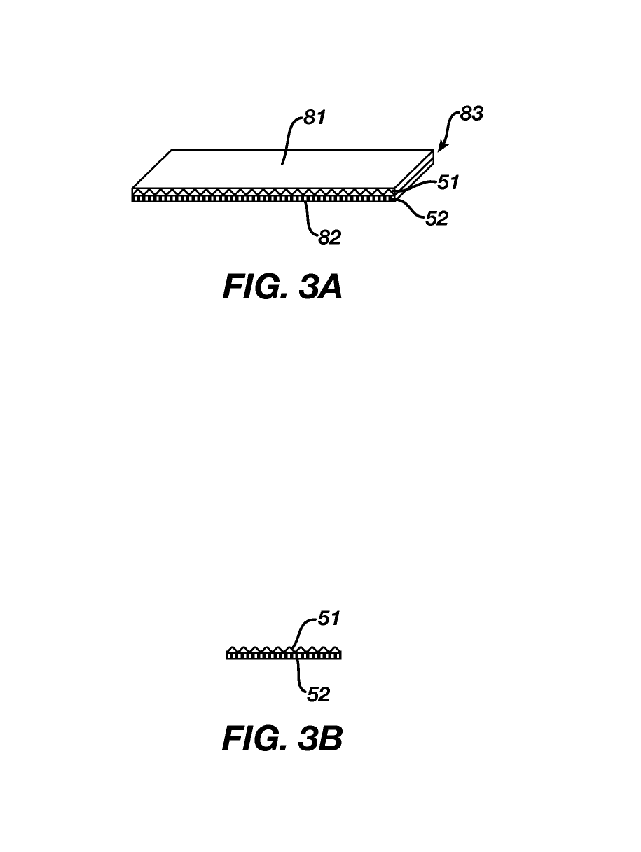

Referring now to FIG. 3, another method of rendering string 20 self-folding is shown. Sheet 81 of first material 51 and sheet 82 of second material 52 are joined together, for instance by rolling, as shown in FIG. 3A, forming bi-layer sheet 83. As shown in FIG. 3B, bi-layer sheet 83 is then cut into strings 20. After that, similarly to the process shown in FIG. 2B, due to different coefficients of contraction or shrinkage on drying of materials 51 and 52, string 20 self-folds or self-wraps into dose form 10.

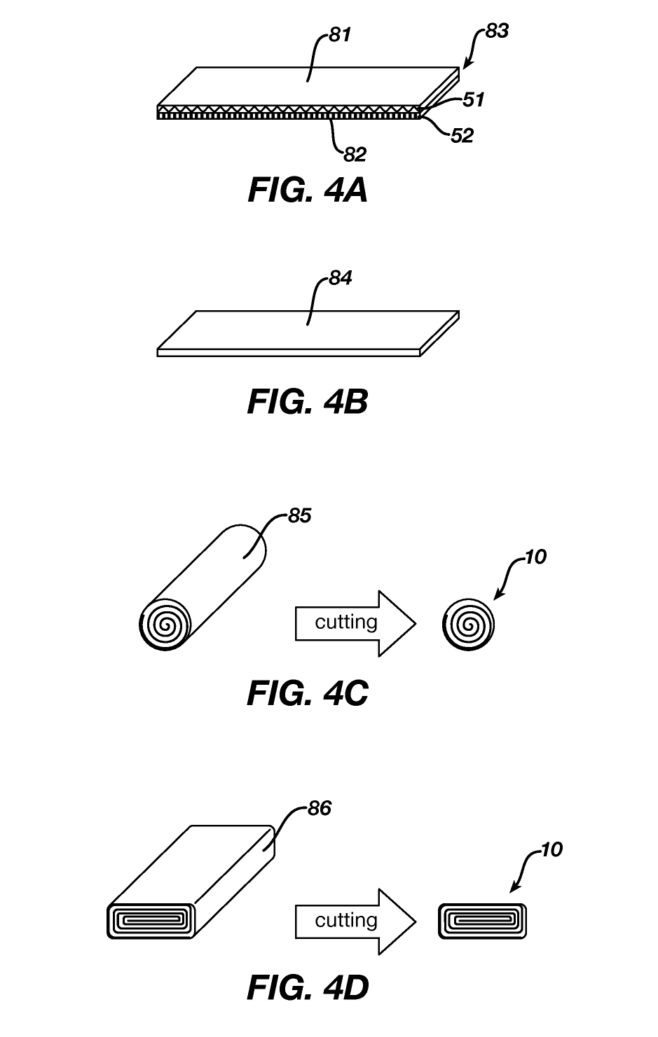

Referring now to FIG. 4, another method of making dose forms 10 is presented. The method comprises steps of forming multilayer (FIG. 4A) sheets 83 comprising layers 81 and 82 made of dissimilar materials 51 and 52, or single layer (FIG. 4B) sheets 84 and then rolling sheets 83 or 84 into cylindrical pre-forms 85 shown in FIG. 4C. The cylindrical pre-forms 85 are then transversely cut (i.e., cut at right angles to the longest axis) into disks forming swallowable dose forms 10 as shown in FIG. 4C, with discs having thickness from about 0.2 mm to about 4 mm, more preferably about 0.3 mm to about 2 mm. The diameter of cylinders 85 is substantially equivalent to the diameter of the dose forms 10 and is from about 5 mm to about 15 mm, more preferably about 7 mm to about 12 mm. As shown in FIG. 4D, sheets 83 or 84 can be rolled into elongated forms having cross-sections of elliptical or substantially rectangular shape or similar. The pre-forms 86 are then transversely cut (i.e., cut at right angles to the longest axis) into capsule-shaped swallowable dose forms 10 having thickness from about 0.2 mm to about 3 mm, as shown in FIG. 4D. One or more of dose forms 10 shown in FIG. 4 can be then encapsulated into optional capsule 30 (not shown in FIG. 4) for ease of swallowing.

In another embodiment, dose form 10 is formed by folding the string multiple times or rolling up into a compact roll and inserting into a capsule 30 which is filled with a liquid, such as aqueous solution or oil, the liquid configured to prevent the strands of the strings from binding to each other.

Dose forms 10 are configured to be of a size acceptable for being swallowed without difficulty by a human. In certain embodiments, dose forms 10 are enterically coated with an enteric coating such as shellac, cellulose acetate phthalate, or other enteric coatings known in the art. Thus the elongated ingestible member is not released in the stomach but is released in the small intestine upon dissolution of the enteric coating.

### Anchoring

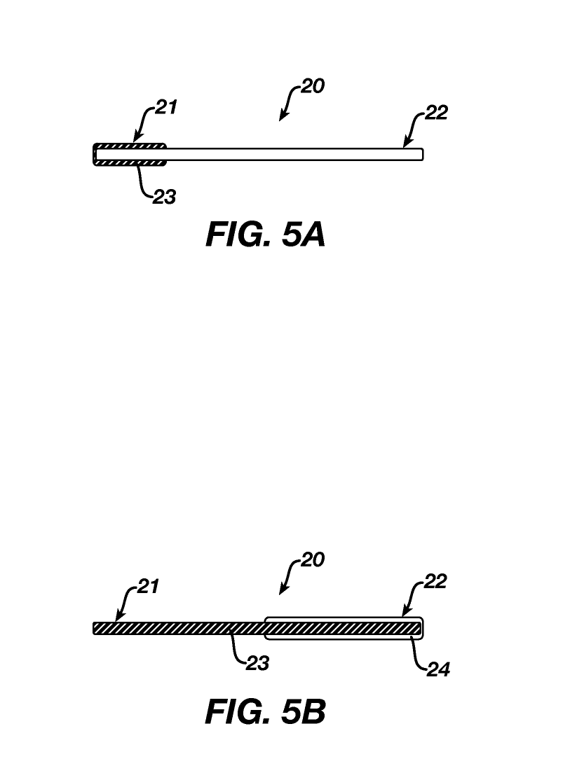

In the embodiment shown in FIG. 5A, elongated ingestible member 20 has a proximal end 21 and a distal end 22, and the proximal end 21 is made of or is coated with an anchoring material 23 facilitating attachment to the intestinal wall. Anchoring materials include carbohydrate-binding proteins (lectins) from plant sources, such as tomato lectin (AT Florence, Pharm. Res. 1997, 14(3), 259-266) or microbial sources such as E. coli (I Ofek and RJ Doyle, Bacterial Adhesion to Cells and Tissues, 1994, Chapman Hall, N.Y.).

In the embodiment shown in FIG. 5B, elongated ingestible member 20 contains materials capable of anchoring to the intestinal wall, with the distal end coated with a coating 24 that has no anchoring properties.

In the embodiments shown in FIG. 5, the proximal end is transiently anchored to the intestinal wall, while the distal end is capable of untangling and moving along the intestine, resulting in the untanglement of the elongated ingestible member and in positioning of the member substantially along the intestinal cavity. The length of the anchoring material 23 available or exposed on the surface of elongated ingestible member 20 is from about 5% to about 50% of the total length of elongated ingestible member 20, such as about 10% or about 25% of the total length of elongated ingestible member 20.

### Materials

Elongated ingestible member 20 is made of ingestible, fully or partially biodegradable material. The material is capable of being stable for at least some of the time while residing in the small intestine. The elongated ingestible member is then fully or partially digested and eliminated from the body through the intestinal tract.

In one embodiment, the material of which elongated ingestible member 20 is constructed is primarily wheat such as durum wheat or wheat derived materials such as semolina, and is similar in composition to pasta, spaghetti, angel hair, or similar nutritional products in elongated form made of wheat or wheat compositions.

In one embodiment, the material of which the degradable string is made is impregnated with alginate and calcium that could swell in the GI tract to produce a sense of fullness, with triggering incretin signals to further suppress appetite.

In certain embodiments, the following materials are utilized for elongated ingestible members or strings 20: polysaccharides; dietary fiber; cellulose and cellulose fibers, methylcellulose, HPMC, chitosan, alginates. In certain embodiments, cellulose strings of cotton fiber 1-2 inch long are utilized.

In certain embodiments, materials 51 contain alginates having substantially negative charge; materials 52 contain chitosan having substantially net positive charge.

In certain embodiments, flour is used as a coating for string 20 and or for dose forms 10.

In certain embodiments, string 20 is formed by co-extruding a suspension of elongated fibers mixed with swellable polysaccharides to form strings 20.

In certain embodiments, the polymers may be polysaccharides that are capable of forming films, or fibers. Examples of polysaccharides capable or forming films include alginate, amylose (a component of starch), carboxymethyl-, or ethylcellulose, (water-soluble derivatives of cellulose), chitosan, (an animal-derived polymer of glucosamine), or pullulan (a non-starch glucose polymer). Films may also contain other components such as small molecules that act as plasticizers and help in water retention, such as glycerol and other polyols.

Multi-layer polymer films may be formed separately before combining to 2 or more films.

### Process

Upon swallowing, elongated ingestible member 20 passes through the stomach substantially non-digested. Optionally, some swelling and/or unfurling can occur in the stomach. In one embodiment, elongated ingestible member 20 while in the compact form or swallowable form 10 is protected by an enteric coating and passes into the small intestine. In the small intestine, elongated ingestible member 20 is deployed as the enteric coating is dissolves.

Elongated ingestible member 20 unravels/uncoils in the intestine and optionally absorbs water and swells. The string that forms in the small intestine is preferably from about 1 to 20 mm in diameter and from about 2 to about 50 cm long. As the string moves through the small intestine it is eventually partially or fully digested.

In some embodiments, elongated ingestible member 20 unravels/uncoils within about 30 minutes to about 5 hours after ingesting, more preferably within about 1 hour to about 2 hours.

### Release of the Elongated Ingestible Member in the Stomach

In one embodiment, elongated ingestible member 20 is enclosed into a capsule 30, such as gelatin capsule, said capsule 30 fully dissolving in the stomach after ingestion. Elongated ingestible member 20 is then released from capsule 30 and untangles in the stomach, but it is not digested in the stomach being made of material configured to be stable in the stomach or being coated with an enteric coating such as shellac, cellulose acetate phthalate, or other enteric coating known in the art. Upon further progression of elongated ingestible member 20 into the intestine, it triggers an initial physiological effect that contributes to the creation of one or more biological signals of satiety.

Nutritional or Bioactive Component Release and/or Encapsulation

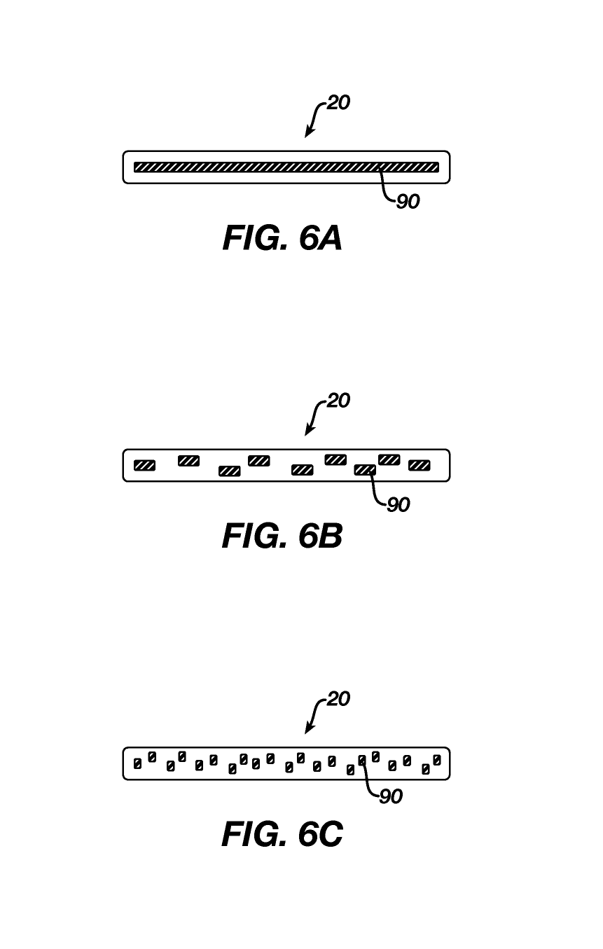

In one embodiment, ingestible elongated member 20 further includes a nutritional or bioactive component capable of signaling satiety. Referring now to FIG. 6A, in one embodiment, liquid, solid, or semi-solid nutritional component 90 is encapsulated inside an elongated cavity in the tubular-shaped elongated member 20. In the embodiment shown in FIG. 6B, nutritional component 90 is encapsulated within micro-beads distributed within ingestible elongated member 20. In the embodiment shown in FIG. 6C, nutritional component 90 is distributed throughout ingestible elongated member 20 without any encapsulation.

Embodiments of ingestible elongated member 20 shown in FIG. 6 may include one or more releasable reservoirs containing one or more bioactive materials. In one embodiment, the triggering of the physiological satiety effect is caused by the release of a bioactive material from ingestible elongated member 20. In certain embodiments, nutritional component 90 forms bioactive material as a by-product of digestion.

Nutritional component 90 is selected from sugars, fatty acids, amino acids, and peptides. In some embodiments nutritional component 90 is vegetable oil. In some embodiments, nutritional component 90 is a drug.

### Ingestible Elongated Member Having Areas for Faster Dissolution

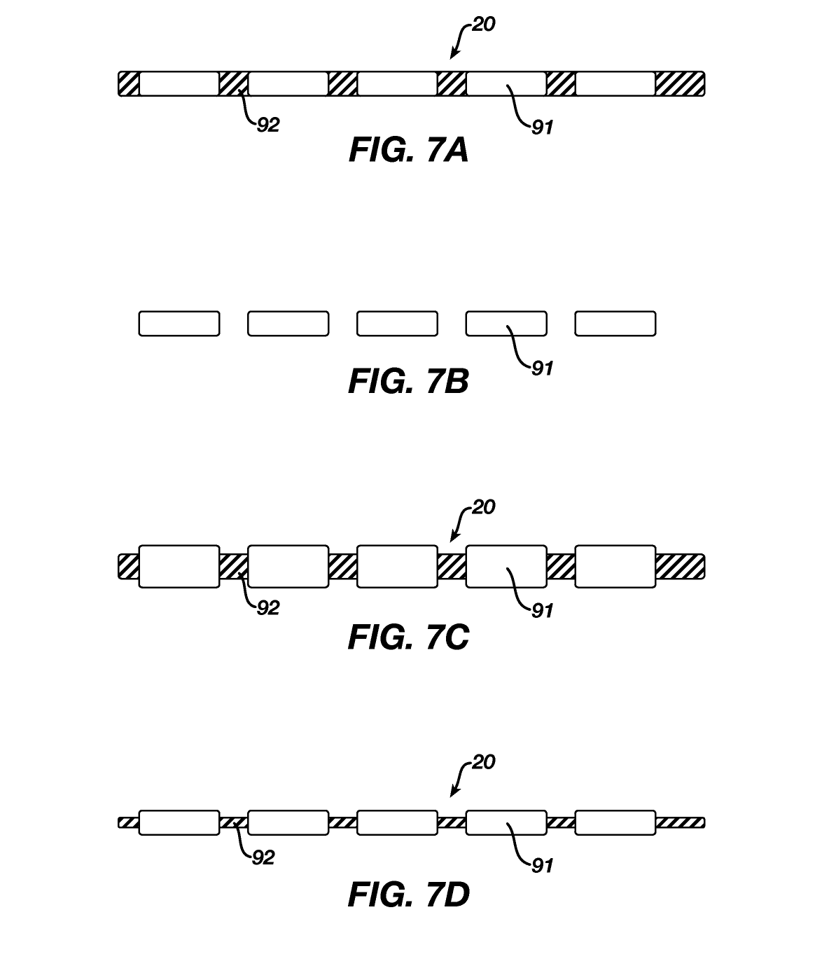

Referring now to FIG. 7A, in certain embodiments, ingestible elongated member 20 has several slow digestible or non-digestible segments 91 (made for instance of insoluble dietary fiber) wherein said segments 91 are separated from each other or linked to each other by linkers 92 which are faster digestible or soluble. In such embodiments, as ingestible elongated member 20 progresses through the GI tract, eventually the faster digestible or soluble linkers 92 will dissolve, leaving the slow digestible or non-digestible segments 91 for further digestion or for being eventually excreted as shown in FIG. 7B.

In certain embodiments, slow digestible or non-digestible segments 91 are more swellable while linkers 92 are non-swellable or less swellable resulting in the formation of the structure of member 20 after exposure to the GI tract environment as shown in the FIG. 7C. Eventually the faster digestible or soluble linkers 92 will dissolve, leaving the slow digestible or non-digestible segments 91 for further digestion or for being eventually excreted as shown in FIG. 7B. In certain embodiments, linkers 92 start to dissolve faster vs. slow digestible or non-digestible segments 91 resulting in the formation of the structure of member 20 after exposure to the GI tract environment as shown in the FIG. 7D. Eventually the faster digestible or soluble linkers 92 will dissolve, leaving the slow digestible or non-digestible segments 91 for further digestion or for being eventually excreted as shown in FIG. 7B.

The invention has been illustrated by the detailed description and the examples. Various changes in form and detail will be within the skill of persons in the art. Therefore, the invention must be measured by the claims and not by the description, the examples or the preferred embodiments. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An ingestible nutritional dose form, comprising:
a furled elongated string having aspect ratio of 5 to 300 packaged into a compact dose form suitable for swallowing whole.

2. The ingestible nutritional dose form of claim 1 made from material selected from the group consisting of soluble dietary fiber, insoluble dietary fiber, wheat, oats, polysaccharides, methylcellulose, HPMC, chitosan, alginates, cotton, and combinations thereof.

3. The ingestible nutritional dose form of claim 1 comprising materials stable in the stomach.

4. The ingestible nutritional dose form of claim 1, wherein said nutritional dose form is coated by an enteric coating.

5. The ingestible nutritional dose form of claim 1, wherein said furled elongated string is packed into a soluble capsule.

6. The ingestible nutritional dose form of claim 1, wherein said furled elongated string comprises partially digestible or non-digestible segments linked by soluble or digestible linkers.

7. The ingestible nutritional dose form of claim 1, wherein said string is swellable in the small intestine.

8. The ingestible nutritional dose form of claim 1, wherein said string separates into segments during digestion in the small intestine.

9. The ingestible nutritional dose form of claim 1, wherein said string comprises anchoring material disposed on one end of the string.

10. The ingestible nutritional dose form of claim 1, wherein said string comprises releasable nutritional or bioactive components.

11. A method of making the ingestible nutritional dose form of claim 1, comprising the steps of:
co-extruding two or more materials having different shrinkage upon drying in an unified elongated form;
cutting the unified elongated form forming a plurality of strings; and
drying the strings allowing the strings to furl.

12. A method of making the ingestible nutritional dose form of claim 1, comprising the steps of rolling a sheet comprising at least one layer of ingestible material into a roll;
cutting the roll transversely into the compact dose forms suitable for swallowing whole.

13. A method of using the ingestible nutritional dose form of claim 1, comprising the steps of
swallowing the ingestible nutritional dose form, resulting in unfurling of the string in the intestine, and
treating obesity in humans by reducing the desire for eating.

14. A method of inducing satiety, comprising:
packaging an elongated at least partially digestible string having aspect ratio of 5 to 300 in a compact swallowable form;
optionally encapsulating said string in a soluble capsule;
optionally coating said compact swallowable form with an enteric coating; and
ingesting said compact swallowable form.
